(19) United States
(12) Patent Application Publication
(10) Pub. No.: US 2025/0034312 A1
(43) Pub. Date: Jan. 30, 2025

(54) MODIFIED POLYURETHANE MATERIAL AND METHOD FOR MANUFACTURING THE SAME

(71) Applicant: KUROKI INDUSTRIAL CO., LTD., New Taipei City (TW)

(72) Inventors: CHIH-LUNG LIN, New Taipei City (TW); YI-JYUN LOU, New Taipei City (TW); WEN-TENG CHANG, New Taipei City (TW); YU-RU WANG, Taipei City (TW); CHEN-TA CHEN, New Taipei City (TW)

(21) Appl. No.: 18/754,129

(22) Filed: Jun. 25, 2024

(30) Foreign Application Priority Data
Jul. 28, 2023 (TW) 112128288

(51) Int. Cl. C08G 18/09; C08G 18/32; C08G 18/34; C08G 18/42; C08G 18/48; C08G 18/75

(52) U.S. Cl. CPC C08G 18/09; C08G 18/3243; C08G 18/346; C08G 18/4244; C08G 18/4854; C08G 18/753; C08G 18/758; C08G 2115/00

(57) ABSTRACT

A modified polyurethane material and a method for manufacturing the same are provided. A dianhydride is added into an aliphatic diisocyanate to form a liquid reactant. A solvent is absent from the liquid reactant. An oligomerization is implemented onto the liquid reactant so as to form an oligomer having a terminal isocyanate group. A polyol and a curative are added into the oligomer having the terminal isocyanate group for a polymerization so as to form the modified polyurethane. Based on a total weight of the modified polyurethane being 100 wt %, a content of a hard segment of the modified polyurethane ranges from 15 wt % to 45 wt %.

### CROSS-REFERENCE TO RELATED PATENT APPLICATION

This application claims the benefit of priority to Taiwan Patent Application No. 112128288, filed on Jul. 28, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a modified polyurethane material and a method for manufacturing the same, and more particularly to a modified polyurethane material without a solvent and a method for manufacturing the same.

### BACKGROUND OF THE DISCLOSURE

Polyurethane is polymerized from a diisocyanate, a polyol, and a curative. Due to the soft texture, the good wear-resistance, the good impact-resistance, and the good elasticity, the polyurethane can be used to produce elastomeric foams, engineering elastomers, or coatings. To date, the polyurethane has been developed to be widely applied in various fields.

However, the polyurethane has poor heat resistance. Hence, an operating temperature of the polyurethane is limited to being not higher than a rubber plateau region of a modulus-temperature curve. In addition, the polyurethane has a high creep. When being subjected to stress for a long period of time (especially under a high temperature), permanent deformation of the polyurethane is likely to occur. Due to this characteristic, the service life of a polyurethane product cannot be prolonged.

Therefore, how to improve the heat resistance and the thermal creep of the polyurethane without sacrificing mechanical properties, so as to enable the operating temperature of the polyurethane to be no longer limited to a temperature range of the rubber plateau region of the modulus-temperature curve, has become an important issue to be addressed in the relevant industry.

### SUMMARY OF THE DISCLOSURE

In response to the above-referenced technical inadequacies, the present disclosure provides a modified polyurethane material and a method for manufacturing the same.

In order to solve the above-mentioned problems, one of the technical aspects adopted by the present disclosure is to provide a method for manufacturing a modified polyurethane material. A dianhydride is added into an aliphatic diisocyanate to form a liquid reactant. A solvent is absent from the liquid reactant. An oligomerization is implemented onto the liquid reactant so as to form an oligomer having a terminal isocyanate group. A polyol and a curative are added into the oligomer having the terminal isocyanate group for polymerization so as to form the modified polyurethane material. Based on a total weight of the modified polyurethane material being 100 wt %, a content of a hard segment of the modified polyurethane ranges from 15 wt % to 45 wt %.

In one of the possible or preferred embodiments, a mole equivalent ratio of the aliphatic diisocyanate to the dianhydride ranges from 1:0.1 to 1:0.3.

In one of the possible or preferred embodiments, when a theoretical content of an isocyanate group remained in the liquid reactant reaches a range from 16 wt % to 31 wt %, the oligomerization is terminated.

In one of the possible or preferred embodiments, an equivalent weight of the oligomer having the terminal isocyanate group ranges from 135 g to 257 g.

In one of the possible or preferred embodiments, an equivalent weight of the polyol ranges from 500 g to 1,500 g.

In one of the possible or preferred embodiments, based on the total weight of the modified polyurethane material being 100 wt %, a content of the dianhydride ranges from 1 wt % to 17 wt %.

In one of the possible or preferred embodiments, the oligomerization is implemented at a temperature ranging from 130° C. to 160° C.

In one of the possible or preferred embodiments, the polymerization is implemented at a temperature ranging from 70° C. to 130° C.

In one of the possible or preferred embodiments, the dianhydride is selected from the group consisting of pyromellitic dianhydride, 3,3′,4,4′-benzophenonetetracarboxylic dianhydride, and 4,4′-oxydiphthalic anhydride.

In one of the possible or preferred embodiments, the aliphatic diisocyanate is selected from the group consisting of isophorone diisocyanate and bis(4-isocyanatocyclohexyl) methane.

In one of the possible or preferred embodiments, the polyol is selected from the group consisting of poly(1,4-butylene adipate) and poly(tetramethylene ether) glycol.

In one of the possible or preferred embodiments, the curative is 4,4′-methylenebis(2-chloroaniline), or a mixture of 1,4-butanediol and triisopropanolamine.

In one of the possible or preferred embodiments, the process of forming the liquid reactant further includes adding an aromatic isocyanate into the liquid reactant. Based on a total weight of the aliphatic diisocyanate and the aromatic isocyanate being 100 wt %, an amount of the aliphatic diisocyanate is higher than 5.0 wt %.

In order to solve the above-mentioned problems, another one of the technical aspects adopted by the present disclosure is to provide a method for manufacturing a modified polyurethane material. A dianhydride is added into an aromatic isocyanate or an isocyanate trimer to form a liquid reactant. A solvent is absent from the liquid reactant. An oligomerization is implemented onto the liquid reactant so as to form an oligomer having a terminal isocyanate group. A polyol and a curative are added into the oligomer having the terminal isocyanate group for polymerization so as to form the modified polyurethane material. A mole equivalent ratio of the aromatic isocyanate to the dianhydride ranges from 1:0.05 to 1:0.15. A mole equivalent ratio of the isocyanate trimer to the dianhydride ranges from 1:0.05 to 1:0.15.

In one of the possible or preferred embodiments, an average number of a functional group in the aromatic isocyanate ranges from 2.1 to 2.9.

In one of the possible or preferred embodiments, an average number of a functional group in the isocyanate trimer is 3.0.

In one of the possible or preferred embodiments, based on the total weight of the modified polyurethane being 100 wt %, a content of a hard segment of the modified polyurethane ranges from 15 wt % to 45 wt %.

In order to solve the above-mentioned problems, yet another one of the technical aspects adopted by the present disclosure is to provide a modified polyurethane material. The modified polyurethane material is manufactured by the method as mentioned above.

Therefore, in the modified polyurethane material and the method for manufacturing the same provided by the present disclosure, by virtue of “a solvent being absent from the liquid reactant” and “subjecting the liquid reactant to oligomerization, so as to form an oligomer having a terminal isocyanate group,” the heat resistance and the thermal creep of polyurethane can be improved without sacrificing mechanical properties.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flowchart of a method for manufacturing a modified polyurethane material according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a method for manufacturing a modified polyurethane material. In the method, no solvent is used. Compared to a conventional method in which the solvent is used, the method of the present disclosure is more eco-friendly. Since a dianhydride is not directly added into a prepolymer for reaction, carbon dioxide will not be generated as a by-product. The carbon dioxide may cause formation of holes or bubbles on a polyurethane product, thereby decreasing the mechanical strength of the polyurethane product.

In order to prevent the usage of the solvent, an aliphatic diisocyanate is chosen to be a reactant, and other reactants are added into the aliphatic diisocyanate. In other words, the aliphatic diisocyanate is used as the reactant and the solvent. Under an environment of room temperature and normal pressure, the aliphatic diisocyanate is in a liquid state, which is beneficial for being used as the reactant and the solvent.

Through selection of specific materials and parameter adjustment, the modified polyurethane material of the present disclosure can have good wear-resistance, good impact-resistance, and good elasticity, and the heat resistance and the thermal creep thereof can be further improved. Therefore, an operating temperature of the modified polyurethane material is no longer limited to a temperature range of a rubber plateau region of a modulus-temperature curve. The modified polyurethane material can be used in a wider range of processes and usages, and have better mechanical properties to withstand greater external forces.

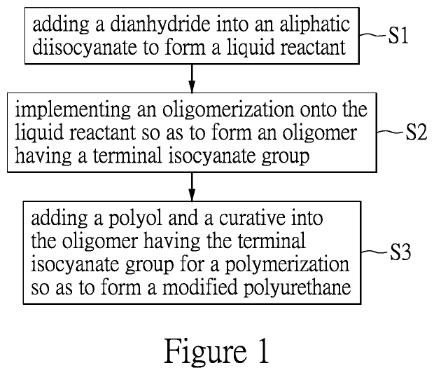

Referring to FIG. 1, the method for manufacturing the modified polyurethane material of the present disclosure includes steps of: adding a dianhydride into an aliphatic diisocyanate to form a liquid reactant (step S1); implementing an oligomerization onto the liquid reactant so as to form an oligomer having a terminal isocyanate group (step S2); and adding a polyol and a curative into the oligomer having the terminal isocyanate group for a polymerization so as to form a modified polyurethane (step S3).

In step S1, in order to achieve a solvent-free process, the aliphatic diisocyanate is chosen to be used as a reactant for its liquid state under an environment of room temperature and normal pressure. For example, the aliphatic diisocyanate is in a liquid state at a temperature ranging from 5° C. to 50° C.

Specifically, the aliphatic diisocyanate can be 1,3-bis(isocyanatomethyl)cyclohexane (H₆XDI), isophorone diisocyanate (IPDI), 1,3-bis(1-isocyanato-1-methylethyl)benzene (TMXDI), 1,3-bis(isocyanatomethyl)benzene (m-XDI), bis(4-isocyanatocyclohexyl) methane (H₁₂MDI), hexamethylene diisocyanate (HDI), or a combination thereof.

If other aliphatic diisocyanates are used, the oligomer will be solidified or precipitated from the liquid reactant after the oligomer reaches a certain equivalent weight. Hence, those aliphatic diisocyanates are not suitable for the method of the present disclosure.

In an exemplary embodiment, the aliphatic diisocyanate can be isophorone diisocyanate (IPDI), bis(4-isocyanatocyclohexyl) methane (H₁₂MDI), or a combination thereof, and the isophorone diisocyanate (IPDI) has a better solubility.

The dianhydride can act as a modifier to connect diisocyanate monomers. Moreover, addition of the dianhydride can also increase the possibility of microphase separation between a soft segment and a hard segment, which can enhance the heat resistance of the modified polyurethane material.

By adjusting types of the dianhydride, content ratios of the reactants, and reaction parameters, the oligomer having an expected equivalent weight can be oligomerized in step S2. Subsequently, the oligomer can react with the polyol and the curative to form the modified polyurethane material. In an exemplary embodiment, the dianhydride is in a powder state, which is beneficial for being quickly dissolved in the aliphatic diisocyanate.

For example, the dianhydride can be pyromellitic dianhydride (PMDA), 1,2,4,5-cyclohexanetetracarboxylic dianhydride (HPMDA), 4,4′-biphthalic anhydride (BPDA), 3,3′,4,4′-benzophenonetetracarboxylic dianhydride (BTDA), 4,4′-(hexafluoroisopropylidene)diphthalic anhydride (6FDA), 4,4′-oxydiphthalic anhydride (ODPA), 3,4,9,10-perylenetetracarboxylic dianhydride (PTCDA), 2,2-bis(4-(3,4-dicarboxyphenoxy)phenyl) propane dianhydride (BPADA), or a combination thereof. However, the present disclosure is not limited thereto.

In an exemplary embodiment, the dianhydride can be pyromellitic dianhydride (PMDA), 3,3′,4,4′-benzophenonetetracarboxylic dianhydride (BTDA), 4,4′-oxydiphthalic anhydride (ODPA), or a combination thereof.

The hard segment of the modified polyurethane material is formed by the aliphatic diisocyanate and the dianhydride. Therefore, how to adjust a mole equivalent ratio of the aliphatic diisocyanate to the dianhydride in step S1 is important. The equivalent weight of the oligomer having the terminal isocyanate group (hereinafter shortened as oligomer) will be indirectly influenced by the mole equivalent ratio of the aliphatic diisocyanate to the dianhydride. Amounts of the hard segment and the soft segment will affect properties of the modified polyurethane material. Therefore, the properties of the modified polyurethane material will be affected by adjusting the equivalent weight of the oligomer.

In order to ensure that the oligomer has the terminal isocyanate group, a mole equivalent of the aliphatic diisocyanate can be higher than a mole equivalent of the dianhydride. For example, the mole equivalent ratio of the aliphatic diisocyanate to the dianhydride can range from 1:0.1 to 1:0.3, such as 1:0.15, 1:0.20, or 1:0.25. However, the present disclosure is not limited thereto.

When the dianhydride is excessively added, the equivalent weight of the oligomer will be too high to be dissolved by the aliphatic diisocyanate, thereby forming precipitation. In another situation, the oligomer having a high equivalent weight will be solidified in the liquid reactant and form solid crystals, which can be dissolved in the polyol only at a temperature of above 130° C. However, a temperature suitable for a casting process ranges from 70° C. to 130° C. If an operation temperature is above 130° C., the casting process may have difficulties to be carried out.

In an exemplary embodiment, the aliphatic diisocyanate is isophorone diisocyanate (IPDI), and the mole equivalent ratio of the aliphatic diisocyanate to the dianhydride ranges from 1:0.1 to 1:0.3. If the amount of the dianhydride is lower than 1:0.3, the oligomer having the high equivalent weight which cannot be dissolved by the aliphatic diisocyanate is easily solidified or precipitated, and cannot be applied in the method of the present disclosure.

When the solvent is absent from the liquid reactant, a solid content of the modified polyurethane material is 100%, and the modified polyurethane material can be used to produce a non-membrane block material. Accordingly, the modified polyurethane material can be directly used in a casting process, and a drying process can be omitted. After mixing the oligomer, the polyol, and the curative, such a mixture can be poured into the casting mold, and then a modified polyurethane product can be directly formed. Since the solvent is absent from the liquid reactant, no solvent is evaporated during formation of the modified polyurethane, and the safety of the working environment can be ensured.

In step S2, in order to obtain the modified polyurethane material with good properties, the dianhydride and the aliphatic diisocyanate are first subjected to the oligomerization, so as to form the oligomer having the terminal isocyanate group. The oligomer having the terminal isocyanate group can be represented by formula (I).

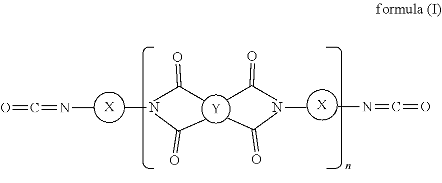

In formula (I), “X” is formed by the aliphatic diisocyanate, and “Y” is formed by the dianhydride. In an exemplary embodiment, “X” can be

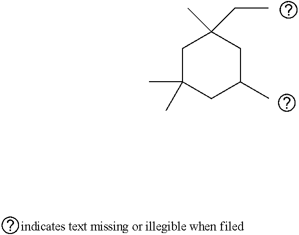

or

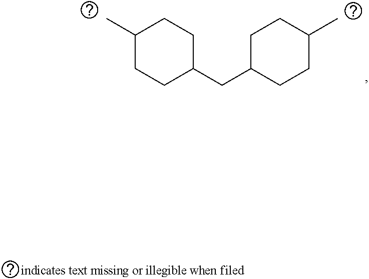

### and “Y” can be

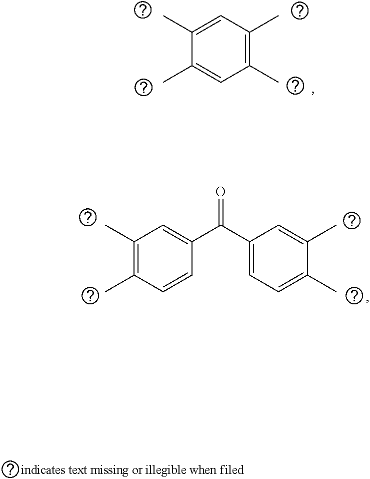

or

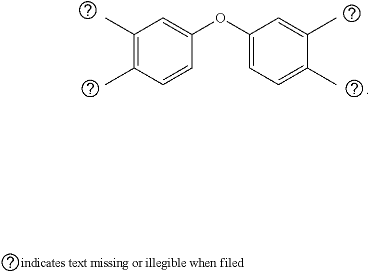

### However, the

present disclosure is not limited thereto.

In the modified polyurethane material, the hard segment is formed from the aliphatic diisocyanate. In the present disclosure, the aliphatic diisocyanate is modified by the dianhydride, and then is reacted with the polyol and the curative. In this way, a chemical structure of the hard segment and a concentration of the dianhydride can be adjusted in advance, such that the modified polyurethane material can have good properties.

The oligomer has a specific degree of polymerization, which is reflected on a chain length of the oligomer. In the present disclosure, the degree of polymerization is quantified by the equivalent weight. In an exemplary embodiment, the equivalent weight of the oligomer ranges from 135 g to 257 g, such as 140 g, 150 g, 160 g, 170 g, 180 g, 190 g, 200 g, 210 g, 220 g, 230 g, 240 g, or 250 g, but the present disclosure is not limited thereto. When the equivalent weight of the oligomer is too high to be dissolved by the aliphatic diisocyanate, the oligomer will be solidified or precipitated, and cannot be used in the method of the present disclosure.

During the oligomerization, a content of the isocyanate group remained in the liquid reactant can be measured to define a reaction endpoint of the oligomerization. Specific details thereof will be illustrated in Examples.

The oligomerization can be implemented at a temperature ranging from 130° C. to 160° C., and preferably at a temperature ranging from 145° C. to 155° C.

In step S3, the polyol and the curative are added into the oligomer for polymerization, so as to form the modified polyurethane material. The soft segment of the modified polyurethane material is mainly formed from the polyol. Therefore, the properties of the modified polyurethane material can be affected by adjusting types and contents of the polyol.

The polymerization can be implemented at a temperature ranging from 70° C. to 130° C. When the mole equivalent ratio of the aliphatic diisocyanate to the dianhydride is lower than 1:0.2, the polyol and the oligomer can be dissolved and undergo the polymerization at a temperature ranging from 110° C. to 130° C. When the mole equivalent ratio of the aliphatic diisocyanate to the dianhydride is higher than 1:0.2, the polyol and the oligomer can be dissolved and undergo the polymerization at a temperature ranging from 70° C. to 100° C.

In order to adjust the mechanical properties of the modified polyurethane material, an equivalent weight of the polyol can range from 500 g to 1,500 g, such as 750 g, 1,000 g, or 1,250 g.

For example, the polyol can be poly(1,4-butylene adipate) (PBA), poly(tetramethylene ether) glycol (PTMEG), or a combination thereof. However, the present disclosure is not limited thereto.

As mentioned above, the hard segment of the modified polyurethane material is formed from the oligomer, and the soft segment of the modified polyurethane material is formed from the polyol. Therefore, an amount ratio of the polyol relative to the oligomer is also an important factor for affecting the properties of the modified polyurethane material. By forming the oligomer (the hard segment) in step S2, and by adding the polyol (the soft segment) in step S3, the chemical structure and properties of the modified polyurethane material of the present disclosure can be precisely controlled.

If the aliphatic diisocyanate and the polyol are reacted in advance to form a prepolymer, and then the dianhydride is added for modification, a large amount of carbon dioxide is produced during chain extension, such that it is difficult to manufacture products that are hole-free. In addition, a temperature for the dianhydride to be dissolved into the prepolymer is higher than a casting temperature, such that a severe reaction may happen, and the prepolymer cannot be injected into a mold for production.

In the present disclosure, the amount of the polyol relative to the oligomer is quantified as the amount of the hard segment in the modified polyurethane material. In an exemplary embodiment, based on a total weight of the modified polyurethane material being 100 wt %, the amount of the hard segment of the modified polyurethane material ranges from 15 wt % to 45 wt %, such as 20 wt %, 25 wt %, 30 wt %, 35 wt %, or 40 wt %.

In steps S3, the curative can further be added to adjust the hardness of the modified polyurethane material. For example, the curative can be a mixture of 4-butanediol (1,4-BDO) and triisopropanolamine (TIPA), or 4,4′-methylenebis(2-chloroaniline) (MOCA). However, the present disclosure is not limited thereto.

In order to illustrate the method for manufacturing the modified polyurethane material of the present disclosure, Examples below are provided for specific descriptions of the polymerization.

### [Polymerization of Oligomer]

Referring to Table 1, in Examples 1 to 5, pyromellitic dianhydride (PMDA), 3,3′,4,4′-benzophenonetetracarboxylic dianhydride (BTDA), or 4,4′-oxydiphthalic anhydride (ODPA) is used as the dianhydride, and isophorone diisocyanate (IPDI) or bis(4-isocyanatocyclohexyl) methane (H₁₂MDI) is used as the aliphatic diisocyanate.

During the oligomerization of the oligomer, the dry dianhydride powder and an amine catalyst are added into the aliphatic diisocyanate, so as to form the liquid reactant. After being uniformly mixed, the liquid reactant is reacted for oligomerization at a temperature ranging from 130° C. to 160° C., so as to form the oligomer having the terminal isocyanate group. During the oligomerization, carbon dioxide is generated.

After oligomerization, the oligomer having the terminal isocyanate group (i.e., the oligomers in Examples 1 to 5) can be obtained. The oligomers in Examples 1 to 5 are titrated to measure an actual content of the isocyanate group in the oligomer. Through a comparison with a theoretical content of the isocyanate group remained in the liquid reactant, the reaction endpoint of the oligomerization can be defined. After calculation, the equivalent weight of the oligomer can be obtained.

In an exemplary embodiment, when the theoretical content of the isocyanate group remained in the liquid reactant reaches 16 wt % to 31 wt %, the oligomerization is terminated.

The difference of Examples 1 to 3 is that different types of the dianhydride are selected for the oligomerization. Example 3 is different from Example 4 in the mole equivalent ratio of the aliphatic diisocyanate to the dianhydride. The difference between Examples 2 and 5 is that different types of the aliphatic diisocyanate are selected for the oligomerization.

TABLE 1

| | | Exam- | Exam- | Exam- | Exam- | Exam- |
|---|---|---|---|---|---|---|
| | | ple 1 | ple 2 | ple 3 | ple 4 | ple 5 |
| Aliphatic | Type | IPDI | IPDI | IPDI | IPDI | H₁₂MDI |
| diisocyanate | Amount | 111.2 | 111.2 | 111.2 | 111.2 | 131.2 |
| | (g) | | | | | |
| Dianhydride | Type | PMDA | BTDA | ODPA | ODPA | BTDA |
| | Amount | 21.8 | 32.2 | 31.0 | 15.5 | 32.2 |
| | (g) | | | | | |

| | | | | | |
|---|---|---|---|---|---|
| Mole equivalent ratio | 1:0.2 | 1:0.2 | 1:0.2 | 1:0.1 | 1:0.2 |
| of aliphatic | | | | | |
| diisocyanate to | | | | | |
| dianhydride | | | | | |
| Equivalent weight of | 166.3 | 179.3 | 177.8 | 140.8 | 204.3 |
| oligomer (g) | | | | | |
| Theoretical content of | 25.3 | 23.5 | 23.7 | 29.9 | 20.6 |
| isocyanate group | | | | | |
| remained in liquid | | | | | |
| reactant (wt %) | | | | | |

### [Polymerization of Modified Polyurethane Material I]

Referring to Table 2, in Examples 6 to 8, the oligomer in Example 2 is used for reacting with the poly(1,4-butylene adipate) (PBA) and the curative, so as to form the modified polyurethane material.

The equivalent weight of the oligomer in Example 2 is 179.3 g. An equivalent weight of the poly(1,4-butylene adipate) (PBA) is 1,000 g. An equivalent weight of a curative mixture is 47.9 g.

During polymerization, 100 g of the polyol (PBA) is vacuumed at 90° C. to remove water, and then is added into the oligomer in Example 2 for uniform stirring. A specific amount of the oligomer is listed in Table 2.

The curative mixture (1,4-BDO/TIPA) including 1,4-butanediol (1,4-BDO) and triisopropanolamine (TIPA) is added, so as to form a reactant mixture. In the curative mixture, a weight ratio of 1,4-butanediol (1,4-BDO) to triisopropanolamine (TIPA) is 4:1. In other words, the curative mixture contains 80 wt % of 1,4-butanediol (1,4-BDO) and 20 wt % of triisopropanolamine (TIPA).

The reactant mixture is injected into a mold with a high temperature, and then is reacted to be solidified at 120° C. After being cooled and demolded, the modified polyurethane material can be obtained. The modified polyurethane material can also undergo a post cure by being placed at 100° C. for 15 hours, so as to produce a casting modified polyurethane product.

Examples 6 to 8 are different from one another in the amount of the hard segment of the modified polyurethane. According to a target amount of the hard segment, the amounts of the oligomer and the curative can be calculated, such that the modified polyurethane having different amounts of the hard segment can be polymerized. According to the amount of the oligomer and the mole equivalent of the dianhydride, the addition amount of the dianhydride can be calculated.

TABLE 2

| | | Example 6 | Example 7 | Example 8 |
|---|---|---|---|---|
| Oligomer | Type | Example 2 | | |
| | Amount (g) | 69.1 | 58.8 | 42.0 |
| Polyester | Type | PBA | | |
| polyol | Amount (g) | 100 | 100 | 100 |
| Curative | Type | Curative mixture (1,4-BDO/TIPA) | | |
| | Amount (g) | 13.1 | 10.5 | 6.1 |
| Modified | Content of | 35 | 30 | 20 |
| polyurethane | hard segment | | | |
| material | (wt %) | | | |
| | Content of | 8.5 | 7.8 | 6.4 |
| | dianhydride | | | |
| | (wt %) | | | |

### [Property Analysis of Modified Polyurethane Material I]

In order to compare the modified polyurethane materials having different contents of the hard segment, a hardness, a rebound resilience, a modulus, a tensile strength at break, an elongation at break, and a toughness are measured and listed in Table 3.

In Table 3, the hardness of the modified polyurethane material is measured according to the standard ASTM D2240. The rebound resilience of the modified polyurethane material is measured according to the standard ASTM D2632. The modulus, the tensile strength at break, and the elongation at break are measured according to the standard ASTM D638 (type V). The toughness is obtained by calculating an area under a stress-strain curve.

TABLE 3

| | Example 6 | Example 7 | Example 8 |
|---|---|---|---|
| Content of hard segment of | 35 | 30 | 20 |
| modified polyurethane (wt %) | | | |
| Hardness (Shore A) | 80 | 75 | 55 |
| Rebound resilience (%) | 28 | 22 | 15 |
| 100% modulus (MPa) | 9.4 | 5.3 | 2.2 |
| 300% modulus (MPa) | 31.3 | 16.3 | 6.3 |
| Tensile strength at break (MPa) | 41.5 | 49.3 | 48.1 |
| Elongation at break (%) | 345 | 487 | 596 |
| Toughness (GJ/m³) | 5.9 | 7.9 | 7.3 |

According to Table 3, the properties of the modified polyurethane material can be affected by the content of the hard segment of the modified polyurethane material. When the content of the hard segment is increased, the modulus of the modified polyurethane material will increase. According to experimental data, based on the total weight of the modified polyurethane material being 100 wt %, when the content of the hard segment of the modified polyurethane material ranges from 27 wt % to 33 wt %, the modified polyurethane material can have good 100% modulus (modulus at 100% elongation) and toughness.

### [Polymerization of Modified Polyurethane Material II]

Referring to Table 4, the oligomers in Examples 1 to 5 are respectively used in Examples 9 to 13, and poly(1,4-butylene adipate) (PBA) or poly(tetramethylene ether) glycol (PTMEG) is used as the polyol. The oligomer, the polyol, and the curative are reacted to form the modified polyurethane material.

The equivalent weight of the oligomer in Example 1 is 166.3 g. The equivalent weight of the oligomer in Example 2 is 179.3 g. The equivalent weight of the oligomer in Example 3 is 177.8 g. The equivalent weight of the oligomer in Example 4 is 140.8 g. The equivalent weight of the oligomer in Example 5 is 204.3 g. The equivalent weight of the poly(1,4-butylene adipate) (PBA) is 1,000 g. The equivalent weight of the poly(tetramethylene ether) glycol (PTMEG) is 1,000 g. The equivalent weight of the curative is 133.6 g. During the polymerization, 100 g of the polyol (PBA or PTMEG) is vacuumed at 90° C. to remove water, and then is added into the oligomers in Examples 1 to 5 for uniform stirring. Specific amounts of the oligomers are listed in Table 4.

Subsequently, 4,4′-methylenebis(2-chloroaniline) (MOCA) is added to be used as a curative. After being vigorously stirred, the reactant mixture is formed. The specific amount of the curative is listed in Table 4.

The reactant mixture is injected into a mold with a high temperature, and then is solidified at 120° C. After being cooled and demolded, the modified polyurethane material can be obtained. The modified polyurethane material can also undergo a post cure by being placed at 100° C. for 15 hours. A casting modified polyurethane product can be obtained.

The difference between Examples 9 to 13 is that different types of the oligomer and the polyol are selected to form the modified polyurethane material, but the content of the hard segment is the same.

In Examples 9 to 13, the amounts of the oligomer and the curative for polymerizing the modified polyurethane material are calculated according to a target content of the hard segment. Further, the amount of the dianhydride of the modified polyurethane material is calculated according to the amount of the oligomer and the mole equivalent of the dianhydride.

### Comparative Example 1

For ease of comparison between the modified polyurethane material and the conventional polyurethane, the polyurethane is polymerized by similar steps mentioned above. Specific steps are illustrated below.

100 g (0.1 mole equivalent) of poly(1,4-butylene adipate) (PBA) is vacuumed at 90° C. to remove water, and then is added into 28.6 g (0.26 mole equivalent) of isophorone diisocyanate (IPDI) for uniform stirring. Subsequently, 4,4′-methylenebis(2-chloroaniline) (MOCA) used as the curative is added to form the reactant mixture after vigorous stirring. Specific amounts of the diisocyanate are listed in Table 4.

The reactant mixture is injected into a mold with a high temperature, and then is solidified at 120° C. After being cooled and demolded, the polyurethane can be obtained. The polyurethane can also undergo a post cure by being placed at 100° C. for 15 hours. A casting polyurethane product can be obtained.

TABLE 4

| | | | | | | | Comparative |
|---|---|---|---|---|---|---|---|
| | | Example 9 | Example 10 | Example 11 | Example 12 | Example 13 | Example 1 |
| Oligomer/ | Type | Example 1 | Example 2 | Example 3 | Example 4 | Example 5 | IPDI |
| diisocyanate | Amount (g) | 39.0 | 41.3 | 41.1 | 34.3 | 45.7 | 28.6 |
| Polyol | Type | PBA | PBA | PTMEG | PTMEG | PBA | PBA |
| | Amount (g) | 100 | 100 | 100 | 100 | 100 | 100 |
| Curative | Type | MOCA | MOCA | MOCA | MOCA | MOCA | MOCA |
| | Amount (g) | 17.1 | 16.6 | 16.7 | 18.3 | 15.7 | 20.0 |
| Modified | Content of hard | 25 | 25 | 25 | 25 | 25 | 25 |
| polyurethane | segment (wt %) | | | | | | |
| material/ | Content of | 4.1 | 5.9 | 5.7 | 2.8 | 5.6 | 0 |
| polyurethane | dianhydride | | | | | | |
| | (wt %) | | | | | | |

### [Property Analysis of Modified Polyurethane Material II]

In order to compare the influences of the different oligomers on the modified polyurethane material, the hardness, the rebound resilience, the modulus, the tensile strength at break, the elongation at break, the toughness, a glass transition temperature, a storage modulus at 100° C. (G′ (100° C.)), a tan δ, an energy loss, a maximum creep strain, and a permanent deformation of the modified polyurethane material in Examples 9 to 13 and the polyurethane in Comparative Example 1 are listed in Table 5.

In Table 5, the glass transition temperature, the storage modulus at 100° C. (G′ (100° C.)), and the tan δ of the modified polyurethane material are measured by a dynamic mechanical analyzer (brand: TECHMAX, model: DMS 6100). The energy loss can be calculated by dividing the tan δ by the storage modulus at 100° C. (G′ (100° C.)).

In Table 5, the maximum creep strain and the permanent deformation are measured by a thermal mechanical analyzer (brand: TA, model: TMA450) at 100° C. Furthermore, a 0.5 N external force is applied for 10 minutes, and then the external force is released for 20 minutes.

Other properties are measured in the same manner as mentioned above, which will not be reiterated herein.

TABLE 5

| | | | | | | Comparative |
|---|---|---|---|---|---|---|
| | Example 9 | Example 10 | Example 11 | Example 12 | Example 13 | Example 1 |
| Content of | 4.1 | 5.9 | 5.7 | 2.8 | 5.6 | 0 |
| dianhydride of | | | | | | |
| modified | | | | | | |
| polyurethane | | | | | | |
| material (wt %) | | | | | | |
| Hardness | 92 | 91 | 87 | 84 | 95 | 84 |
| (Shore A) | | | | | | |
| Rebound | 32 | 32 | 47 | 56 | 37 | 34 |
| resilience (%) | | | | | | |
| 100% modulus | 8.2 | 6.6 | 9.1 | 7.0 | 14.8 | 5.0 |
| (MPa) | | | | | | |
| 300% modulus | 55.1 | 39.0 | — | — | — | 24.0 |
| (MPa) | | | | | | |
| Tensile strength | 57.5 | 66.1 | 29.5 | 40.2 | 39.1 | 64.4 |
| at break (MPa) | | | | | | |
| Elongation at | 305 | 360 | 237 | 291 | 191 | 434 |
| break (%) | | | | | | |
| Toughness | 5.6 | 7.0 | 2.8 | 3.8 | 3.1 | 8.2 |
| (GJ/m³) | | | | | | |
| Glass transition | −37.8 | 0.1 | −61.4 | −58.3 | −44.2 | −44.5 |
| temperature (° C.) | | | | | | |
| Storage modulus | 0.26 | 0.21 | 0.30 | 0.25 | 0.49 | 0.14 |
| (100° C.) | | | | | | |
| (×10⁸ Pa) | | | | | | |
| tanδ (100° C.) | 0.12 | 0.12 | 0.08 | 0.08 | 0.10 | 0.13 |
| Energy loss | 0.46 | 0.57 | 0.27 | 0.32 | 0.20 | 0.93 |
| Maximum creep | 2.6 | 4.1 | 2.5 | 2.5 | 2.2 | 7.7 |
| strain (%) | | | | | | |
| Permanent | 0.6 | 0.9 | 1.0 | 0.9 | 1.0 | 1.3 |
| deformation (%) | | | | | | |

According to the results in Table 5, the modified polyurethane material of the present disclosure has a low energy loss, a low maximum creep strain, and a low permanent deformation. In other words, compared to the conventional polyurethane, the modified polyurethane material of the present disclosure has a better heat resistance and a better tensile strength at high temperature, thereby improving the high thermal creep of the conventional polyurethane.

The modified polyurethane material is formed by the soft segment and the hard segment. When the contents of the soft segment and the hard segment are within a specific range, the microphase separation happens, such that the soft segment and the hard segment are prone to show their own characteristics. For example, the soft segment is prone to promote the elasticity and the properties of low temperature, and the hard segment is prone to promote the rigidity and the properties of high temperature. Therefore, when the microphase separation happens, the glass transition temperature of the modified polyurethane material will decrease; while, the thermal creep of the modified polyurethane material is also decrease which represent a better thermal stability.

Referring to Examples 11 and 12, the modified polyurethane material can have a lower glass transition temperature (which represents a better low temperature resistance) when the isophorone diisocyanate (IPDI), the 4,4′-oxydiphthalic anhydride (ODPA), and the poly(tetramethylene ether) glycol (PTMEG) are selected for polymerization. In addition, having a lower maximum creep strain represents that the modified polyurethane material has a better thermal creep resistance.

The difference between Example 11 and Example 12 is that the mole equivalent ratio of the aliphatic diisocyanate to the dianhydride in Example 11 is 1:0.2, and the mole equivalent ratio of the aliphatic diisocyanate to the dianhydride in Example 12 is 1:0.1. According to the results in Example 11 and Example 12, the modified polyurethane material can have a higher modulus but a lower toughness when the modified polyurethane material has a larger amount of an imide structure (a higher amount of the dianhydride).

The difference between Example 10 and Example 13 is that the isophorone diisocyanate (IPDI) is used as the aliphatic diisocyanate in Example 10, and bis(4-isocyanatocyclohexyl) methane (H₁₂MDI) is used as the aliphatic diisocyanate in Example 13. According to the results in Example 10 and Example 13, when the modified polyurethane material contains a cyclic structure, the modified polyurethane can have a higher modulus, but a lower toughness.

The difference between Example 9 and Example 10 is that pyromellitic dianhydride (PMDA) is used as the dianhydride in Example 9, and 3,3′,4,4′-benzophenonetetracarboxylic dianhydride (BTDA) is used as the dianhydride in Example 10. According to the results in Example 9, Example 10, and Comparative Example 1, the modified polyurethane material of the present disclosure can have a better modulus. In addition, when the dianhydride contains a carbonyl structure, the modified polyurethane will have a lower modulus but a higher toughness.

### [Solubility Test of Liquid Reactant]

In addition to the above experiments, the liquid reactant having varying concentrations and types of diisocyanates are tested to see whether the oligomer is solidified or precipitated during the oligomerization process, so as to be suitable for the method of the present disclosure.

### [Test 1]

The isophorone diisocyanate (IPDI) and the pyromellitic dianhydride (PMDA) are chosen to form the liquid reactant. The mole equivalent ratio of the isophorone diisocyanate (IPDI) to the pyromellitic dianhydride (PMDA) is adjusted to test whether the oligomer is solidified or precipitated during the oligomerization.

TABLE 6

| | Test 1-1 | Test 1-2 | Test 1-3 | Test 1-4 |
|---|---|---|---|---|
| Mole | 1:0.1 | 1:0.2 | 1:0.3 | 1:0.4 |
| equivalent ratio | | | | |
| of IPDI to | | | | |
| PMDA | | | | |
| Solubility | Still in a | Still in a | Solidification | Severe |
| during | liquid | liquid | (occurred when | reaction and |
| oligomerization | state | state | an | solidification |
| | | | oligomerization | |
| | | | temperature is | |
| | | | lower than | |
| | | | 160° C.) | |

According to the result in Table 6, when the mole equivalent ratio of the isophorone diisocyanate (IPDI) to the pyromellitic dianhydride (PMDA) is 1:0.4, the liquid reactant is solidified due to a severe reaction. Therefore, when the aliphatic diisocyanate is chosen to be used as a main component of the liquid reactant, the mole equivalent ratio of the isophorone diisocyanate (IPDI) to the pyromellitic dianhydride (PMDA) ranges from 1:0.1 to 1:0.3. Preferably, the mole equivalent ratio of the isophorone diisocyanate (IPDI) to the pyromellitic dianhydride (PMDA) ranges from 1:0.1 to 1:0.28.

### [Test 2]

The diphenylmethane diisocyanate (MDI) and the pyromellitic dianhydride (PMDA) are chosen to form the liquid reactant. The mole equivalent ratio of the diphenylmethane diisocyanate (MDI) to the pyromellitic dianhydride (PMDA) is adjusted to test whether the oligomer is solidified or precipitated during the oligomerization.

In Test 2, an average functional group quantity of an isocyanate group of the diphenylmethane diisocyanate (MDI) is 2.0.

TABLE 7

| | Test 2-1 | Test 2-2 |
|---|---|---|
| Mole equivalent ratio of | 1:0.05 | 1:0.1 |
| MDI to PMDA | | |
| Solubility during | Oligomer | Oligomer |
| oligomerization | precipitation | precipitation |

According to the result in Table 7, when the mole equivalent ratio of the diphenylmethane diisocyanate (MDI) to the pyromellitic dianhydride (PMDA) ranges from 1:0.05 to 1:0.1, the oligomer precipitation is generated. Therefore, the diphenylmethane diisocyanate (MDI) is not suitable to be used as a main component of the liquid reactant.

### [Test 3]

The diphenylmethane diisocyanate (MDI), the isophorone diisocyanate (IPDI), and the pyromellitic dianhydride (PMDA) are chosen to form the liquid reactant. When the mole equivalent ratio of the diphenylmethane diisocyanate (MDI) (the aromatic isocyanate) to the isophorone diisocyanate (IPDI) (the aliphatic diisocyanate) to the pyromellitic dianhydride (PMDA) (the dianhydride) is 0.9:0.1:0.2, the liquid reactant will not be solidified or precipitated during the oligomerization, and the subsequent polymerization may proceed.

In Test 3, the diphenylmethane diisocyanate (MDI) having an equivalent weight of 125.1 is used as the aromatic isocyanate. Based on a total weight of the aliphatic diisocyanate and the aromatic isocyanate being 100 wt %, the amount of the aliphatic diisocyanate is higher than 9 wt %, such that the oligomer will not be solidified or precipitated during the oligomerization.

### [Test 4]

The 2,2-bis(4-isocyanatophenyl) hexafluoropropane (HFP), the isophorone diisocyanate (IPDI), and the pyromellitic dianhydride (PMDA) are chosen to form the liquid reactant. When the mole equivalent ratio of the 2,2-bis(4-isocyanatophenyl) hexafluoropropane (HFP) (the aromatic isocyanate) to the isophorone diisocyanate (IPDI) (the aliphatic diisocyanate) to the pyromellitic dianhydride (PMDA) (the dianhydride) is 0.9:0.1:0.2, the liquid reactant will not be solidified or precipitated during the oligomerization, and the subsequent polymerization may proceed.

In Test 4, the 2,2-bis(4-isocyanatophenyl) hexafluoropropane (HFP) having an equivalent weight of 193.1 is used as the aromatic isocyanate. Based on the total weight of the aliphatic diisocyanate and the aromatic isocyanate being 100 wt %, the amount of the aliphatic diisocyanate is higher than 6 wt %, such that the oligomer will not be solidified or precipitated during the oligomerization.

According to Test 3 and Test 4, the aliphatic diisocyanate and the aromatic isocyanate can be mixed at a specific ratio, and then the dianhydride can be added to form the liquid reactant. Specifically, based on the total weight of the aliphatic diisocyanate and the aromatic isocyanate being 100 wt %, the amount of the aliphatic diisocyanate is higher than 5 wt %, such that the oligomer will not be solidified or precipitated during the oligomerization. Preferably, the amount of the aliphatic diisocyanate is higher than 10 wt %.

### [Test 5]

The polymethylene polyphenyl isocyanate (crude MDI) and the pyromellitic dianhydride (PMDA) are chosen to form the liquid reactant. The mole equivalent ratio of the polymethylene polyphenyl isocyanate (crude MDI) to the pyromellitic dianhydride (PMDA) is adjusted to evaluate whether the liquid reactant is solidified or precipitated during the oligomerization.

In Test 5, an average functional group quantity of an isocyanate group of the polymethylene polyphenyl isocyanate (crude MDI) ranges from 2.1 to 2.9.

TABLE 8

| | Test 5-1 | Test 5-2 |
|---|---|---|
| Mole equivalent ratio of crude | 1:0.1 | 1:0.2 |
| MDI to PMDA | | |
| Solubility during | Still in a | Oligomer |
| oligomerization | liquid state | precipitation |

According to the result in Table 8, when the mole equivalent ratio of the polymethylene polyphenyl isocyanate (crude MDI) to the pyromellitic dianhydride (PMDA) is 1:0.2, the liquid reactant is precipitated during the oligomerization. Therefore, when the aromatic isocyanate (which has more than two functional groups) is chosen to be used as a main component of the liquid reactant, the mole equivalent ratio of the polymethylene polyphenyl isocyanate (crude MDI) to the pyromellitic dianhydride (PMDA) ranges from 1:0.05 to 1:0.15.

### [Test 6]

The tris(6-isocyanatohexyl) isocyanurate (trimeric HDI) and the pyromellitic dianhydride (PMDA) are chosen to form the liquid reactant. The mole equivalent ratio of the tris(6-isocyanatohexyl) isocyanurate (trimeric HDI) to the pyromellitic dianhydride (PMDA) is adjusted to evaluate whether the liquid reactant is solidified or precipitated during the oligomerization.

In Test 6, an average functional group quantity of an isocyanate group of the tris(6-isocyanatohexyl) isocyanurate (trimeric HDI) is 3.0.

TABLE 9

| | Test 6-1 | Test 6-2 |
|---|---|---|
| Mole equivalent ratio of trimeric | 1:0.1 | 1:0.2 |
| MDI to PMDA | | |
| Solubility during oligomerization | Still in a | Oligomer |
| | liquid state | solidified |

According to the result in Table 9, when the mole equivalent ratio of the tris(6-isocyanatohexyl) isocyanurate (trimeric HDI) to the pyromellitic dianhydride (PMDA) is 1:0.2, the liquid reactant is solidified during the oligomerization. Therefore, when the aromatic isocyanate (which has three functional groups) is chosen to be used as a main component of the liquid reactant, the mole equivalent ratio of the tris(6-isocyanatohexyl) isocyanurate (trimeric HDI) to the pyromellitic dianhydride (PMDA) ranges from 1:0.05 to 1:0.15.

According to Test 5 and Test 6, the aliphatic diisocyanate can be replaced by the specific aromatic isocyanate (an average functional group quantity of an isocyanate group ranging from 2.1 to 2.9) or the isocyanate trimer (an average functional group quantity of an isocyanate group being 3.0), and the dianhydride can be added to the aromatic isocyanate or the isocyanate trimer for formation of the liquid reactant.

Specifically, when the average functional group quantity of the isocyanate group of the aromatic isocyanate ranges from 2.1 to 2.9, the mole equivalent ratio of the aromatic isocyanate to the dianhydride in the liquid reactant ranges from 1:0.05 to 1:0.15. Specifically, when the average functional group quantity of the isocyanate group of the isocyanate trimer is 3.0, the mole equivalent ratio of the isocyanate trimer to the dianhydride in the liquid reactant ranges from 1:0.05 to 1:0.15.

### Beneficial Effects of the Embodiments

In conclusion, in the modified polyurethane material and the method for manufacturing the same provided by the present disclosure, by virtue of “a solvent being absent from the liquid reactant” and “subjecting the liquid reactant to oligomerization, so as to form an oligomer having a terminal isocyanate group,” the heat resistance and the thermal creep of the polyurethane can be improved without sacrificing the mechanical properties.

Further, the addition amount of the monomers will also affect the properties of the modified polyurethane material. In order to polymerize the oligomer having the terminal isocyanate group which has the equivalent weight ranging from 135 g to 257 g, the amounts of the aliphatic diisocyanate and the dianhydride are controlled. The oligomerization reaction is controlled by measuring the content of the isocyanate group remained in the liquid reactant. During the polymerization reaction, different types of the polyol, the oligomer, and the curative are selected for reaction. In this way, the modified polyurethane material of the present disclosure having good heat resistance and good thermal creep can be obtained.

Specifically, based on the total weight of the modified polyurethane material being 100 wt %, when the content of a hard segment of the modified polyurethane material ranges from 15 wt % to 45 wt %, the modified polyurethane material can have good heat resistance and good thermal creep.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a modified polyurethane material, comprising:
adding a dianhydride into an aliphatic diisocyanate to form a liquid reactant, wherein a solvent is absent from the liquid reactant;
subjecting the liquid reactant to oligomerization, so as to form an oligomer having a terminal isocyanate group; and
adding a polyol and a curative into the oligomer having the terminal isocyanate group for polymerization, so as to form the modified polyurethane material;
wherein, based on a total weight of the modified polyurethane material being 100 wt %, a content of a hard segment of the modified polyurethane material ranges from 15 wt % to 45 wt %.

2. The method according to claim 1, wherein a mole equivalent ratio of the aliphatic diisocyanate to the dianhydride ranges from 1:0.1 to 1:0.3.

3. The method according to claim 2, wherein, when a theoretical content of an isocyanate group remained in the liquid reactant reaches a range from 16 wt % to 31 wt %, the oligomerization is terminated.

4. The method according to claim 1, wherein an equivalent weight of the oligomer having the terminal isocyanate group ranges from 135 g to 257 g.

5. The method according to claim 1, wherein an equivalent weight of the polyol ranges from 500 g to 1,500 g.

6. The method according to claim 1, wherein, based on the total weight of the modified polyurethane material being 100 wt %, a content of the dianhydride ranges from 1 wt % to 17 wt %.

7. The method according to claim 1, wherein the oligomerization is implemented at a temperature ranging from 130° C. to 160° C.

8. The method according to claim 1, wherein the polymerization is implemented at a temperature ranging from 70° C. to 130° C.

9. The method according to claim 1, wherein the dianhydride is selected from the group consisting of pyromellitic dianhydride, 3,3′,4,4′-benzophenonetetracarboxylic dianhydride, and 4,4′-oxydiphthalic anhydride.

10. The method according to claim 1, wherein the aliphatic diisocyanate is selected from the group consisting of isophorone diisocyanate and bis(4-isocyanatocyclohexyl) methane.

11. The method according to claim 1, wherein the polyol is selected from the group consisting of poly(1,4-butylene adipate) and poly(tetramethylene ether) glycol.

12. The method according to claim 1, wherein the curative is 4,4′-methylenebis(2-chloroaniline), or a mixture of 1,4-butanediol and triisopropanolamine.

13. The method according to claim 1, wherein the process of forming the liquid reactant further includes adding an aromatic isocyanate into the liquid reactant; wherein, based on a total weight of the aliphatic diisocyanate and the aromatic isocyanate being 100 wt %, an amount of the aliphatic diisocyanate is higher than 5.0 wt %.

14. A method for manufacturing a modified polyurethane material, comprising:
adding a dianhydride into an aromatic isocyanate or an isocyanate trimer to form a liquid reactant, wherein a solvent is absent from the liquid reactant, a mole equivalent ratio of the aromatic isocyanate to the dianhydride ranges from 1:0.05 to 1:0.15, and a mole equivalent ratio of the isocyanate trimer to the dianhydride ranges from 1:0.05 to 1:0.15;
subjecting the liquid reactant to oligomerization, so as to form an oligomer having a terminal isocyanate group; and
adding a polyol and a curative into the oligomer having the terminal isocyanate group for polymerization, so as to form the modified polyurethane material.

15. The method according to claim 14, wherein an average number of a functional group in the aromatic isocyanate ranges from 2.1 to 2.9.

16. The method according to claim 14, wherein an average number of a functional group in the isocyanate trimer is 3.0.

17. The method according to claim 14, wherein, based on a total weight of the modified polyurethane material being 100 wt %, a content of a hard segment of the modified polyurethane material ranges from 15 wt % to 45 wt %.

18. A modified polyurethane material manufactured by the method as claimed in claim 1.

19. A modified polyurethane material manufactured by the method as claimed in claim 2.

20. A modified polyurethane material manufactured by the method as claimed in claim 10.

21. A modified polyurethane material manufactured by the method as claimed in claim 13.
